(19) United States
(12) Patent Application Publication
(10) Pub. No.: US 2017/0152974 A1
(43) Pub. Date: Jun. 1, 2017

(54) HOSE-LINE CONNECTOR AND LINE ASSEMBLY

(71) Applicant: VOSS Automotive GmbH, Wipperfurth (DE)

(72) Inventors: Reiner Mitterer, Wipperfurth (DE); Bernd Steinbach, Wipperfurth (DE); Ulrich Erb, Koln (DE); Ulrich Hiltemann, Wermelskirchen (DE)

(21) Appl. No.: 15/372,015

(22) Filed: Dec. 7, 2016

Related U.S. Application Data
(62) Division of application No. 13/845,873, filed on Mar. 18, 2013, now abandoned.
Application No. 13/845,873 is a division of application No. 12/747,392, filed on Jun. 10, 2010, now abandoned.

(30) Foreign Application Priority Data
Dec. 12, 2007 (DE) 202007017460.8

(51) Int. Cl. F16L 25/12; F16L 39/02; F16L 33/30; F16L 3/22; F16L 33/02

(52) U.S. Cl. CPC F16L 25/12; F16L 3/22; F16L 33/02; F16L 33/30; F16L 39/02

(57) ABSTRACT

The present invention provides a line assembly having a junction part, hose connection piece and a hose-line attached and fastened to the hose connection piece. The hose connection piece has, at its free front end, a sealing portion with a circumferentially smooth sealing surface that is free of molding seams. Thereafter, the hose connection piece includes a holding portion. The hose-line is clamped radially over its circumference by two clamps located in in two axially spaced regions of its attached end, specifically, in a region of the sealing portion and in a region of the holding portion.

### CROSS REFERENCE TO RELATED APPLICATION

This application is a divisional of U.S. patent application Ser. No. 13/845,873, filed Mar. 18, 2013, which is a divisional application of U.S. patent application Ser. No. 12/747,392, filed Jun. 10, 2010, which are herein incorporated by reference.

### BACKGROUND AND SUMMARY

The present invention relates first to a line connector, consisting of a junction part with at least one hose connection piece for attaching and fastening a media hose-line.

The invention also relates, furthermore, to a line assembly, consisting of at least one line connector and at least one hose-line attached and fastened at least at one end to an associated hose connection piece. The line assembly may also consist of two line connectors which are connected to one another by at least one hose-line, in that the hose-line is connected at each of the two ends by means of a hose connection piece.

To join flexible hose-lines, hose connection pieces with what is known as a pinetree profile are known, which have on their outer circumferential surface a plurality of circumferential toothed edges lying axially one behind the other. In this case, an attached hose-line, above all in the case of higher media pressures, always has to be fastened by means of a clamping element, such as a hose clip or a pinch sleeve, because a hose-line, due to its flexibility, cannot alone ensure a sufficient radial restoring force and therefore a sufficient axial holding force in the pull-off direction. Sealing off always takes place by means of the toothed edges, in that these cooperate sealingly with the entire circumference with the inner surface of the hose-line. Known hose connection pieces are therefore predominantly metallic lathe-turned parts, this being burdensome in terms of production costs and material costs.

Furthermore, line connectors with a plurality of, for example two, hose connection pieces are known, which, depending on the application, may be provided for different system pressures of the respective medium. For a relatively lower pressure, for example down to 10 bar, the respective hose-line can be secured by means of a conventional hose clip. For a higher pressure, for example above 15 bar, usually pinch sleeves, as they are known, are used, which surround the hose-line seated with one end on the hose connection piece and which have to be pinched radially by means of special pinching tools. Since such pinching tools require a relatively large amount of space in the region surrounding the pinch sleeve to be deformed, in such known multiple connectors the hose connection pieces must have a large spacing from one another, but this, overall, leads to a disadvantageously large form of construction of the line connector.

The object on which the present invention is based is to provide a line connector of the type described, which, along with simple and cost-effective production, makes it possible to seal off and hold the hose-line effectively. Moreover, particularly with regard to a multiple connector, a compact form of construction is also to be achieved when pinch sleeves are used.

For this purpose, according to the invention, there is provision whereby the junction part, together with the hose connection piece, is formed as an, in particular, one-piece molding produced in a non-cutting manner by a primary molding method or forming method, such as injection molding, extrusion or thixoforming, the hose connection piece having at its free front end a sealing portion with a circumferentially smooth sealing surface, free of molding seams and, thereafter, a holding portion, in such a way that an attached hose-line can be circumferentially clamped radially, preferably twofold, specifically, on the one hand, in the region of the sealing portion and, on the other hand, in the region of the holding portion. Production as a molding is highly efficient. Thus, the molding can be produced as a plastic injection molding from a rigid dimensionally stable plastic, for example from a fiber-reinforced polyamide, such as PA 6.6 with a glass fiber fraction GF 30 or GF 35 or with a corresponding carbon fiber fraction (CF fraction). Preferably, however, it is also possible to produce the molding as a metal die-casting, from aluminum, magnesium or the like. In this case, it is advantageous if the hose connection piece is produced, in the region of the sealing portion, with axial removal from the mold and therefore so as to be free of molding seams on the sealing surface and also, in the remaining region of the holding portion, with radial removal from the mold and therefore with the formation of molding seams running axially. Thus, immediately after the molding operation or the operation of removal from the mold, the sealing surface is seal-free, that is to say without any remachining, thus ensuring a good seal within the hose-line. In the region of the holding portion, however, the molding seams running axially on diametrically opposite sides are harmless, because, of course, sealing takes place by means of the preceding seam-free sealing portion.

The holding portion is preferably designed in such a way that, in the attached and radially clamped state, the hose-line is held positively against being pulled off. For this purpose, the holding portion has at least one form fit element projecting radially beyond the circumference of the sealing portion and having an undercut surface thereby formed. Advantageously, the form fit element may be designed as a radially projecting, bead-shaped or conically widening annular extension at the transition between the sealing portion and the holding portion, an undercut surface being formed as a radial annular step. The twofold clamping of the hose-line then takes place in each case axially on both sides of the annular extension in the regions of the sealing portion and of the holding portion. After the annular extension, the holding portion may have an essentially cylindrical surface region; in this surface region, the clamping of the hose-line for positively holding it against being pulled off axially takes place.

In a version of the line connector a multiple connector with at least two hose connection pieces, according to the invention these are preferably arranged next to one another in parallel with a small spacing, one hose connection piece projecting with a greater length beyond the other hose connection piece, specifically at least with the region of the sealing portion and of the holding portion. By virtue of this advantageous configuration, which may also be provided independently of the configuration according to the invention of the/each hose connection piece according to claim 1, a small compact form of construction is achieved, but a mounting of a pinch sleeve can nevertheless take place, because sufficient surrounding space for a pinching tool is present in the axially projecting region of the longer hose connection piece. In a second mounting step, a hose can then be attached onto the adjacent shorter hose connection piece and be secured by means of two conventional hose clips or one double clip. A small spacing between the two hose connection pieces is sufficient for this purpose.

Further advantageous refinements of the invention are contained in the dependent claims and the following description.

### BRIEF DESCRIPTION OF THE DRAWINGS

The invention will be explained in more detail below by means of the drawings and preferred exemplary embodiments and examples of use illustrated therein. In the drawings:

FIG. 1 shows a perspective view of a part region of a line connector according to the invention in a version as a double connector with two hose connection pieces,

FIG. 2 shows a top view of the line connector seen in FIG. 1 when generally viewed in the direction of arrow II,

FIG. 3 shows an illustration of the line connector, as in FIG. 2, but as a line assembly with joined hose-lines,

FIG. 4 shows an enlarged side view of an end portion of one of the hose connection pieces seen in FIG. 1 when generally viewed in the direction of arrow IV,

FIG. 5 shows an alternative embodiment of the hose connection piece seen in FIG. 4 when generally viewed from a viewing direction corresponding to arrow V,

FIG. 6 shows a perspective side view of the hose connection piece seen in FIG. 5 when generally viewed in the direction of arrow VI,

FIG. 7 shows a diagrammatic illustration of the molding operation or operation of removal of the line connector from the mold during the production, for example, of the connection piece version according to FIG. 5 and FIG. 6,

FIG. 8 shows a line assembly which includes, for example, two line connectors and two hose-lines connecting the line connectors together,

FIG. 9 shows a diagrammatic illustration of a line assembly with an additional hose holding part,

FIG. 10 shows a separate sectional view of the hose holding part according to FIG. 9,

FIGS. 11a to c show, in each case, an axial half section of the hose connection piece in additional embodiments, and

FIG. 12 shows a further embodiment of the hose connection piece, similar to that seen in FIG. 6.

### DETAILED DESCRIPTION

In the various figures in the drawing, identical parts are always given the same reference symbols.

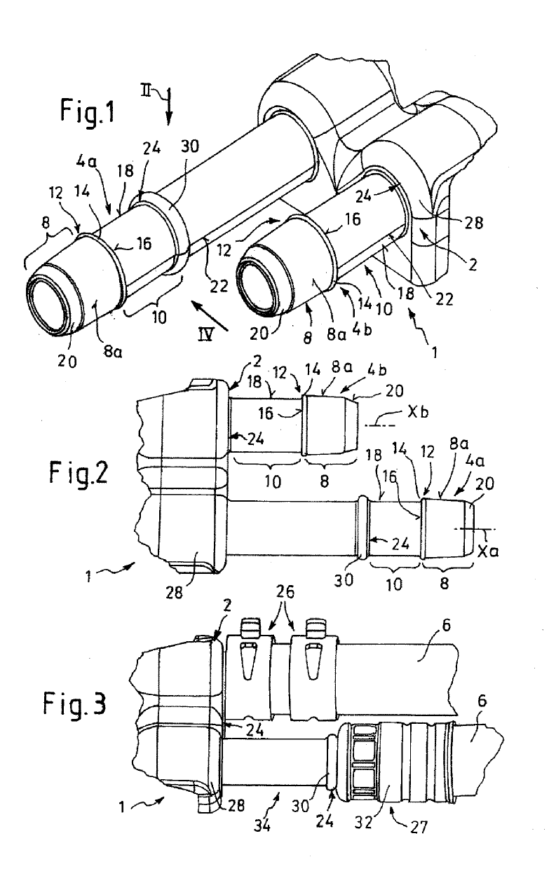

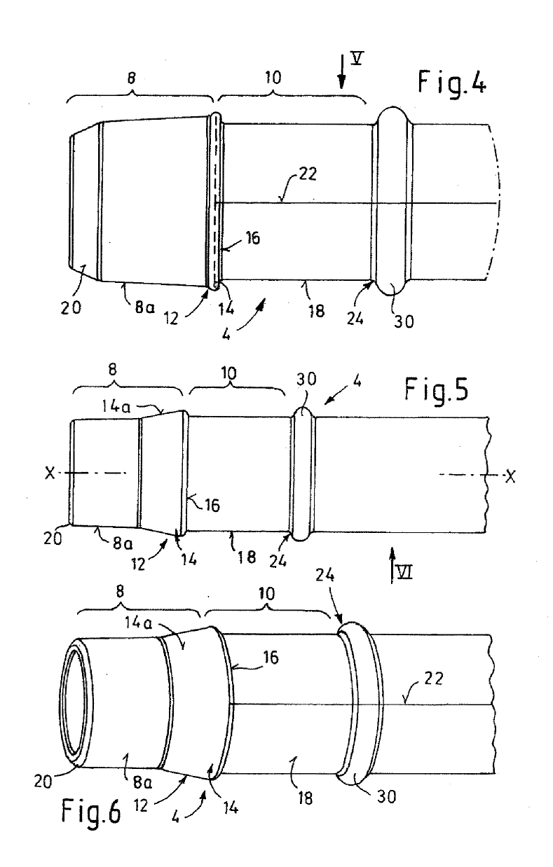

A line connector 1 according to the invention includes a junction part 2 with at least one hose connection piece 4, 4a or 4b (see FIGS. 4 to 6). In the preferred exemplary embodiments according to FIGS. 1 to 3 and 8, the junction part 2 has two hose connection pieces 4a and 4b. Each hose connection piece 4 and 4a, 4b serves for attaching and fastening a flexible media hose-line 6 (see FIGS. 3, 8 and 9).

The/each hose-line 6, in its state attached at the end to the associated hose connection piece 4 and 4a or 4b, should, in addition to being held, be clamped radially over its circumference, in order to ensure sufficient securing against being pulled off

According to the invention, then, there is provision whereby the junction part 2, together with hose connection piece or hose connection pieces 4 and 4a, 4b, is produced as an, in particular, one-piece molding. In this case, the/each hose connection piece 4; 4a, 4b has at its free front end a sealing portion 8 with a circumferentially smooth sealing surface 8a, free of molding seams, and, thereafter, a holding portion 10, in such a way that two clamping regions lying axially one behind the other are formed for an attached hose-line 6. An attached hose-line 6 can thereby be circumferentially clamped radially, at least twofold, specifically, on the one hand, in the region of the sealing portion 8 and, on the other hand, in the region of the holding portion 10. The holding portion 10 is in this case designed in such a way that the hose-line 6, in the radially clamped state, is held positively against being pulled off. For this purpose, the holding portion 10 has at least one form fit element 12 projecting radially beyond the largest circumference of the sealing portion 8. In the preferred versions illustrated, the form fit element 12 is designed as a radially projecting annular extension 14, extending over the entire circumference, at the transition between the sealing portion 8 and the holding portion 10. In the first embodiment according to FIGS. 1, 2 and 4, the annular extension 14 is of bead-shaped design. In an alternative embodiment according to FIGS. 5 and 6, the annular extension 14 widens conically from the sealing surface 8a. In both cases, therefore, a radial holding step 16 is formed as an undercut surface. After this radial holding step 16 of the annular extension 14, the holding portion 10 may have an essentially cylindrical surface region 18. In this surface region 18, the radial clamping of the hose-line 6 for the purpose of holding it positively takes place.

The sealing portion 8 may, in the region of its sealing surface 8a, be designed conically (FIGS. 1, 2 and 4) or approximately cylindrically (FIG. 5, 6), but, in particular, on account of axial removal from the mold, in any event at least slightly conically with a molding slope of, for example, 0 to 3°. Preferably, at the free end, an introduction sloping surface 20 is formed which makes it easier to attach the hose-line 6.

In the version according to FIGS. 5 and 6, the sealing surface 8a is basically enlarged by means of a conical surface 14a of the conically widening annular extension 14.

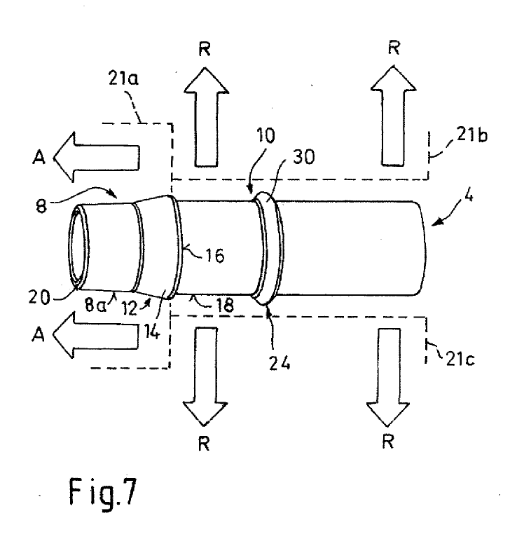

As illustrated diagrammatically in FIG. 7, in the production according to the invention of the line connector 1 or junction part 2, the/each hose connection piece 4 (4a, 4b) is removed, in the region of the sealing portion 8, axially (arrows A) from a circumferentially closed molding die part 21a indicated by dashes. The region which is removed axially from the mold extends from the free end of the hose connection piece as far as the largest diameter of the contiguous annular extension 14 (cf. also FIG. 4). Up to this region the largest diameter of the annular extension 14, therefore, molding seams are advantageously avoided. In the remaining region of the hose connection piece, radial removal from the mold (arrows R) takes place as a result of the opening of two die halves 21b, 21c so as to form molding seams 22 running axially, such as are indicated by way of example in FIGS. 1, 4 and 6.

In a further advantageous refinement, the/each hose connection piece 4 (4a, 4b) has after the holding portion 10 a stop 24 to limit the attachment of the hose-line 6 and preferably also of a single clamp 26 or of a double clamp 27 (see, in particular, FIG. 3). In this case, the stop 24 may be formed by a base part 28 of the junction part 2 or by a, for example, bead-shaped annular extension 30 of the hose connection piece 4 or 4a, 4b.

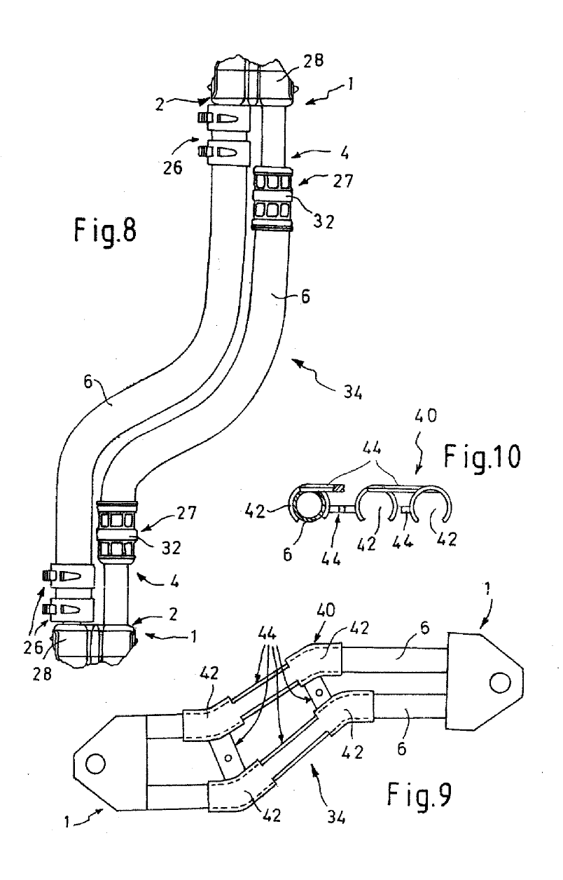

As may be gathered, furthermore, particularly from FIG. 3 and also from FIG. 8, each hose-line 6 may advantageously be radially clamped twofold in its end region attached to the associated hose connection piece, specifically either by means of two single clamps 26 or by means of one double clamp 27. Clamping takes place in the regions of the sealing portion 8 and of the holding portion 10 and therefore axially next to the preferred annular extension 14 on both sides. As a result, on the one hand, optimal sealing off and, on the other hand, a very good positive hold of the hose-line 6 are achieved. Possible deformations of the hose-line 6 out of its circular inner cross-sectional form which are caused by the clamping in the region of the holding portion 10 are advantageously equalized (compensated) by means of the annular extension 14, so that such possible deformations cannot continue in the region of the sealing portion 8.

As regards the preferred version of the line connector 1 as a multiple or double connector, the (at least) two hose connection pieces 4a, 4b are arranged, with respect to their longitudinal axes Xa, Xb, (see FIG. 2), adjacently to one another, in particular in parallel, but, if appropriate, also at an (acute) angle to one another, and in this case are designed with a different length. One hose connection piece 4a projects with a greater length beyond the other hose connection piece 4b, specifically at least with the region of the sealing portion 8 and of the holding portion 10. As a result, the hose connection pieces 4a, 4b can be arranged with a very small spacing from one another. Nevertheless, a pinch sleeve 32 designed, in particular, as a double clamp 27 can be mounted in the end region of the longer hose connection piece 4a. In the region of the holding portion 10, the pinch sleeve 32 is preferably deformed in a star-like manner in cross section. However, in the region of the sealing portion 8, preferably the pinch sleeve 32 is deformed uniformly radially inward over its circumference, in order to achieve a sealing action which is uniform over the circumference. Basically, however, a pinching similar to that in the holding portion 10 may also be provided in the region of the sealing portion 8; cf., in this respect, the exemplary embodiment in FIG. 8.

As may be gathered, then, from FIGS. 3, 8 and 9, a line assembly 34 according to the invention consists of at least one line connector 1, particularly in an embodiment according to the invention, and of at least one hose-line 6. In this case, the hose-line 6 attached to the associated hose connection piece 4 and 4a or 4b is clamped radially over its circumference in two axially spaced regions, specifically, on the one hand, in the region of the sealing portion 8 and, on the other hand, in the region of the holding portion 10 of the hose connection piece. For the radial clamping of the hose-line 6, in this case, two single clamps 26 or one double clamp 27 are provided. In the examples illustrated, conventional hose clips are provided as single clamps 26. The double clamp 27 is formed by the pinch sleeve 32.

Each of the line connectors 1 illustrated diagrammatically in FIG. 9 may be designed, for joining to a counterconnector, not illustrated, for example any desired unit, in the manner of a flange, in which case a corresponding duct orifice is formed for the or each hose connection piece in a flange sealing surface which points toward the drawing plane in FIG. 9 and therefore cannot be seen. To seal off the duct transition, the/each duct orifice is surrounded by a seal which acts as an axial seal between sealing surfaces and which is preferably fixed captively, in particular formed on in a materially integral manner. This makes mounting for joining purposes simple and reliable, because the/each seal is prevented from falling off or from slipping out of place. Moreover, the/each seal formed from an elastic material also brings about tolerance compensation, this being especially advantageous with regard to the production of the line connector 1 or of the junction part 2 as a primary-molded or formed molding. The/each seal may in this case be formed into an annular groove in a materially integral manner. Alternatively or additionally, the junction part 2 may also have a plastic layer injection-molded around it over its area.

As may also be gathered from FIGS. 8 to 10, there are applications in which the/each hose-line 6 of the line assembly 34 is not to be arranged in a straight line, but with a bent profile form. Basically, for this purpose, hoses of bent form could be used, which are preformed with the profile required in each case in a relatively dimensionally stable manner. This results, however, in complicated production, and therefore preformed hoses of this type are very costly. Usually, therefore, hoses are used as continuous stock cut to length. In this case, however, an elastic restoring force may impede optical mounting, because, during mounting, a specific force always has to be applied in order to position the/each hose-line in the profile form desired in each case.

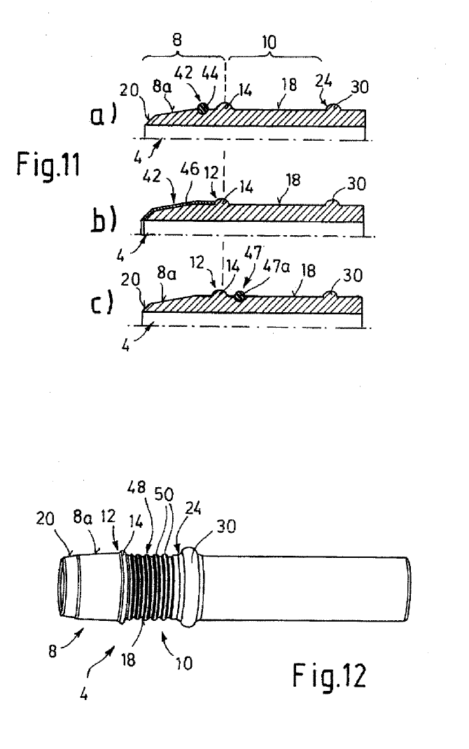

For such applications, therefore, at least one hose holding part 40 is provided according to FIGS. 9 and 10. This holding part 40 is formed in such a way and can be releasably fastened to the/each hose-line 6 in such a way that the hose-line 6 can be preoriented in a specific imparted profile form. For this purpose, the hose holding part 40 has clasp-like hose receptacles 42, in each case with a curved profile adapted to a desired bend profile of the hose-line 6. In each case, at least two hose receptacles 42 are connected here, in particular in one piece, via at least one connecting web 44. The receptacles 42 are designed to be open to one side in such a way that the hose-line 6 can be introduced transversely with respect to its longitudinal axis so as to be latched nonpositively. In the embodiment illustrated in FIGS. 9 and 10, the holding part 40 has two pairs of two receptacles 42 each, with the result that two adjacent hose-lines 6 can be brought into a specific, for example S-shaped, profile form.

Advantageously, a premounting of the hose-lines 6 with the holding part 40 may even take place on the premises of the manufacturer of the complete line assembly 34. Elastic restoring forces of the hose-lines are thereby taken up (absorbed). The holding part 40 has a material-saving configuration in that the receptacles 42 are provided only at bending points of the hose-lines. The spacing desired in each case between the hose-lines 6 is likewise defined by webs 44.

Optionally, the holding part 40 may have mounting aids for final mounting, particularly in the region of the connecting webs 44. These mounting aids may be formed by bores, tenons or other elements, on which, for example, an assembly robot can engage.

In a ready-mounted state of the line connectors 1, if appropriate, the holding parts 40 may be removed. These are actually, to that extent, mainly a mounting aid.

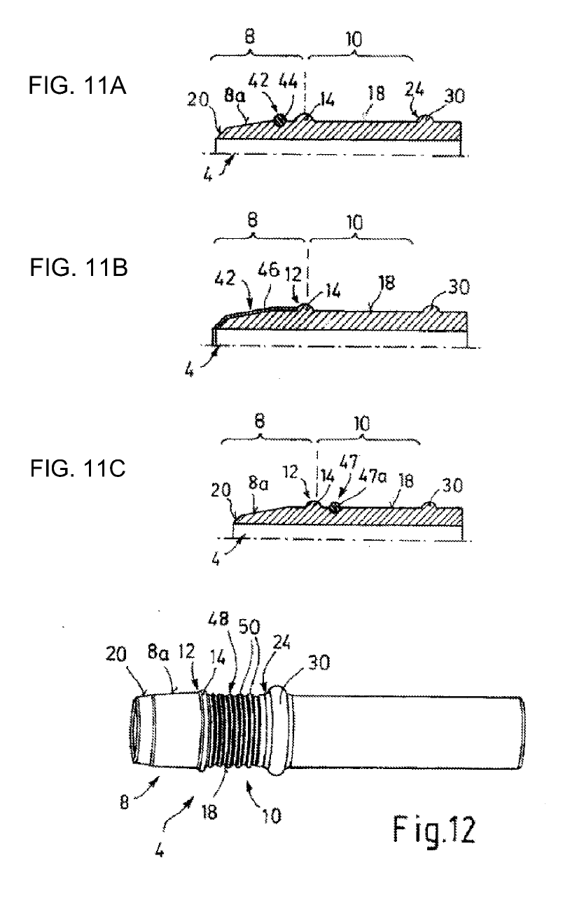

In the versions of the hose connection piece 4 which are illustrated in FIGS. 11a and b, an additional sealing means 52 consisting particularly of an elastomeric material for circumferential sealing off is arranged in the region of the sealing portion 8. According to FIG. 11a, the sealing means 42 provided may be a sealing ring 54, for example in the form of an O-ring or of a profile ring (form ring), the sealing ring 44 preferably being seated in a correspondingly formed reception depression (annular groove). Alternatively, the sealing ring 54 may also be injection-molded on. In the version according to FIG. 11b, the sealing means 42 is a cap-like envelope 46. This envelope 46, too, may be attached as a separate part or else be inj ection-molded on.

Additionally or alternatively to the sealing means 52 in the region of the sealing portion 8 of the hose connection piece 4, a special hose-line may also be used which has inside it, in the region of its free end to be attached to the hose connection piece 4, a sealing means, particularly in the form of an annular bead projecting radially inward (not illustrated in the drawing).

Furthermore, in addition to the sealing means 52 in the region of the sealing portion 8 or, according to FIG. 11c, alternatively to this, and, in particular, elastomeric circumferential sealing means 47, for example in the form of at least one sealing ring 47a put in place or injection-molded on, may also be arranged in the region of the holding portion 10. Since the sealing means 47 or the sealing ring 47a is arranged axially between the annular extensions 14, 30, particularly in the vicinity of the front annular extension 14 facing the sealing portion 8, even an only simple radial clamping of the attached hose-line 6 in the region of the holding portion 10 may be sufficient for holding and sealing off.

As regards the embodiment of the hose connection piece 4, as illustrated in FIG. 12, in this case the essentially cylindrical surface region 18 has additional radially projecting holding means 48, in order to achieve an additional positive or nonpositive/positive holding connection to the hose-line 6. In the exemplary embodiment illustrated, these holding means 48 are designed as a plurality of annular webs 50 arranged axially one behind the other. These may also form a tooth-like holding contour.

The invention is not restricted to the exemplary embodiments illustrated and described, but rather also embraces all versions acting identically in the context of the invention. Furthermore, the invention has hitherto also not yet been restricted to the feature combination defined in the respective independent claim, but may also be defined by any other combination of specific features of all the individual features disclosed as a whole. This means that, basically, virtually any individual feature of the respective independent claim may be omitted or be replaced by at least one individual feature disclosed elsewhere in the application. The claims are to that extent to be understood merely as a first attempt at a formulation of an invention.

I/We claim:

1. A line assembly comprising:
a junction part with at least one hose connection piece for attaching and fastening at least one hose-line, the junction part, together with the hose connection piece, is produced as a primary-molded or formed molding, the hose connection piece having at a free front end a sealing portion with a circumferentially smooth sealing surface being free of molding seams, the sealing portion including an introduction sloping surface at the free front end, the hose connecting piece having thereafter a holding portion including molding seams extending axially thereof, the sealing portion and the holding portion defining and forming two clamping regions lying axially one behind another for attaching a hose-line so that twofold radial clamping is possible with one clamping being in the region of the sealing portion and the other clamping being in the region of the holding portion, the holding portion including at least one form fit element projecting radially beyond the sealing surface, the form fit element being provided as a conically widened annular extension defining a holding step at a transition between the sealing portion and the holding portion, the holding portion further including a cylindrical surface region adjacent to the form fit element, the cylindrical surface region further including a plurality of annular ribs provided therein; and
the at least one hose-line attached and fastened at one end on the at least one hose connection piece, the at least one hose-line extending over both the sealing portion and the holding portion, a first clamp provided about the at least one hose-line in clamped engagement over the sealing portion, a second clamp axially spaced from the first clamp and provided about the at least one hose line in clamped engagement over the holding portion, the first and second clamps each clamping radially over a circumference of the at least one hose-line, wherein the form fit element positively holds the hose-line from being pulled off when the hose line is circumferentially radially clamped to the connection piece.

2. The line assembly as recited in claim 1, wherein the sealing portion is one of a cylindrical and conical shape.

3. The line assembly as recited in claim 1, wherein at least one of the sealing portion and the holding portion has an elastomeric sealing ring mounted thereon.

4. The line assembly as recited in claim 1, wherein the hose connection piece includes a stop, the holding portion being located between the stop and the sealing portion, the stop configured to limit attachment of the hose-line and a clamping element on the hose-line on the hose-connection piece.

5. The line assembly recited in claim 1, wherein the junction part is formed with a first hose connection piece and a second hose connection piece, the first and second hose connection pieces defining respective longitudinal axes arranged parallel to one another, the first hose connection piece having a projecting length that is greater than a projecting length of the second hose connection piece.

6. The line assembly of claim 5, wherein the sealing portion and the holding portion of the first hose connection piece are located axially beyond the sealing portion and the holding portion of the second hose connection piece.

7. The line assembly of claim 1, wherein the first and second clamps are provided as two single clamps.

8. The line assembly of claim 1, wherein the first and second clamps are integrally provided as a double clamp.

9. The line assembly of claim 8, wherein the double clamp is a double pinch sleeve, the double pinch sleeve being deformed uniformly radially inward over its entire circumference in the region of the sealing portion.

10. The line assembly of claim 9, wherein the line connection has at least two hose connection pieces including a first hose connection piece of a first length and a second hose connection piece of a second length, the first hose connection piece being longer than the second hose connection piece, a first hose-line being attached to the first hose connection piece by the double pinch sleeve, and a second hose-line being attached to the second hose connection piece by two individual clamps.

11. The line assembly of claim 1, wherein the hose-line is pre-oriented with an imparted bend profile form.

12. The line assembly of claim 11, further comprising a hose holding part having clasp hose receptacles, the clasp hose receptacles having a curved profile corresponding to the bend profile form.

13. The line assembly of claim 12, wherein the hose holding part includes at least two hose receptacles interconnected by at least one connecting web.

14. The line assembly of claim 1, wherein each hose-line has, in the region of its free end attached to the hose connection piece, at least one annular bead projecting radially inward of the hose line.
